(19) United States
(12) Patent Application Publication
(10) Pub. No.: US 2016/0020083 A1
(43) Pub. Date: Jan. 21, 2016

(54) ADJUSTING PRECURSOR ION POPULATIONS IN MASS SPECTROMETRY USING DYNAMIC ISOLATION WAVEFORMS

(71) Applicant: PRESIDENT AND FELLOWS OF HARVARDD COLLEGE, Cambridge, MA (US)

(72) Inventors: Graeme Conrad McAlister, Cambridge, MA (US); Steven P. Gygi, Foxborough, MA (US)

(73) Assignee: President and Fellows of Harvard College, Cambridge, MA (US)

(21) Appl. No.: 14/772,395

(22) PCT Filed: Mar. 12, 2014
(86) PCT No.: PCT/US2014/023851

§ 371 Date: Sep. 3, 2015

Related U.S. Application Data
(60) Provisional application No. 61/783,268, filed on Mar. 14, 2013.

(51) Int. Cl. H01J 49/42

(52) U.S. Cl. CPC H01J 49/428

(57) ABSTRACT

A mass spectrometry technique for isolating a plurality of isolated ions from a plurality of injected ions using a dynamic isolation waveform to create at least one isolation notch. Isolating the plurality of isolated ions may include collecting at least a first target ion, but not a second target ion, using the at least one isolation notch for a first period of time; changing at least one property of the at least one isolation notch; and collecting at least the first target ion and the second target ion using the at least one isolation notch for a second period of time.

### RELATED APPLICATIONS

This patent application claims the benefit of U.S. provisional patent application No. 61/783,268, titled “ADJUSTING PRECURSOR ION POPULATIONS IN MASS SPECTROMETRY USING DYNAMIC ISOLATION WAVEFORMS,” filed Mar. 14, 2013, which is incorporated herein by reference in its entirety.

### FEDERALLY SPONSORED RESEARCH

This invention was made with government support under 5R01HG003456-07 awarded by National Institutes of Health. The government has certain rights in the invention.

### BACKGROUND OF INVENTION

This application relates generally to mass spectrometry and specifically to a technique for adjusting precursor ion populations in mass spectrometry analysis.

Mass spectrometry is a technique that analyzes a sample by identifying the mass-to-charge ratio of constituent parts of the sample. Mass spectrometry (MS) has many applications in the study of proteins, known as proteomics. MS may be used to characterize and identify proteins in a sample or to quantify the amount of particular proteins in a sample.

It is known to analyze proteins, peptides or other large molecules in a multistep process. In the example of a protein analysis, in a first portion of the process, the protein may be broken into smaller pieces, such as peptides. Certain of these peptides may be selected for further processing. Because the peptides are ions—or may be ionized by known processes such as electrospray ionization (ESI), matrix-assisted laser desorption/ionization (MALDI), or any other suitable process—selection, manipulation, and analysis may be performed using an ion trap. Depending on their frequency of oscillation, ions of different mass-to-charge ratios (m/z—where m is the mass in atomic mass units and z is the number of elemental charges) may be excited by an excitation signal with sufficient energy to escape the ion trap. What remains in the trap following excitation are ions that did not have a mass-to-charge ratio corresponding to the excitation signal. To isolate ions with a particular mass-to-charge ratio, the ion trap may be excited with a signal that includes a range of frequencies except the frequency that excites the ions of interest. Such an excitation signal, also referred to as an isolation waveform, is said to have a frequency “notch” corresponding to the target ion that is to be isolated.

The selected ions remaining in the trap may be again broken into smaller pieces, generating smaller ions. These ions may then be further processed. Processing may entail selecting and further breaking up the ions. The number of stages at which ions are selected and then broken down again may define the order of the mass spectrometry analysis, such as MS2 (also referred to as MS/MS) or MS3. Regardless of the order, at the end stage, the mass-to-charge distribution of the ions may be measured, providing data from which properties of the compound under analysis may be inferred. The ions prior to a fragmentation are sometimes called “precursor” ions and the ions resulting from a fragmentation are sometimes called “product ions.” The mass-to-charge distribution may be acquired for any group of product ions. Moreover, all or a subset of product ions from one stage of MS may be used as precursor for a subsequent stage of MS.

The above multistep process may be time consuming. It is known to increase the throughput of a mass spectrometry facility by analyzing multiple scans at the same time, which is sometimes referred to as “multiplexing” the scans. In traditional multiplexed MS analysis, each precursor ion being isolated is typically isolated one at a time in a serial manner, one after the other. An isolation waveform is applied with a single isolation notch to isolate a particular precursor ion. Then, the resulting precursor ion population is moved to an intermediate storage vessel. This process is repeated serially with single notch waveforms until the intermediate vessel contained the desired number of precursor ions. Following accumulation of the plurality of precursor ions, the entire ensemble is fragmented and the resulting fragment ions are analyzed. In another implementation, each precursor ion is fragmented individually and then the resulting fragment ions are moved to the intermediate ion storage vessel.

In another implementation, “multiplexing” can include the use of specially designed chemical tags, such as tandem mass tags (TMTs) and isobaric tags for relative and absolute quantitation (iTRAQ), which provided the ability to perform multiplexed quantitation of a plurality of samples simultaneously. Performing multiplexed quantitation allows the relative quantities of particular proteins or peptides between samples to be determined. For example, multiplexed quantitation may be used to identify differences between two tissue samples, which may comprise thousands of unique proteins.

The chemical tags are included in reagents used to treat peptides as part of sample processing. A different tag may be used for each sample. Each of the plurality of tags is isobaric, meaning they have nominally the same mass. This is achieved by using different isotopes of atoms in the creation of the tags. For example, a first tag may use a Carbon-12 atom at a particular location of the molecule, whereas as second tag may use a Carbon-13 atom—resulting in a weight difference of one atomic mass unit at that particular location. This purposeful selection of particular isotopes may be done at a plurality of locations for a plurality of elements. As a whole, each isotope of each tag is selected so that the different types of tags have the same total mass resulting in tagged precursor ions with nominally the same mass despite being labeled with a different type of tag. The different isotopes are strategically distributed within the tag molecule such that the portion of the tag molecule that will become a reporter ion for each type of tag has a different weight. Thus, when the different types of tags are fragmented during the MS analysis techniques, each type of tag will yield reporter ions with distinguishable mass-to-charge (m/z) ratios. The intensity of the reporter ion signal for a given tag is indicative of the amount of the tagged protein or peptide within the sample. Accordingly, multiple samples may be tagged with different tags and simultaneously analyzed to directly compare the difference in the quantity of particular proteins or peptides in each sample.

### BRIEF SUMMARY OF INVENTION

In traditional multiplexed MS analysis, each precursor ion being isolated is typically isolated one at a time in a serial manner, one after the other. An isolation waveform was applied with a single isolation notch to isolate a particular precursor ion. Then, the resulting precursor ion population would be moved to an intermediate storage vessel. This process would be repeated serially with single notch waveforms until the intermediate vessel contained the desired number of precursor ions. The inventors have recognized and appreciated that the above process is inefficient and that valuable time can be saved by using a dynamic isolation waveform to isolated precursor ions.

Accordingly, some embodiments are directed to a method of performing mass spectrometry. The method includes isolating a plurality of isolated ions from a plurality of injected ions using a dynamic isolation waveform to create at least one isolation notch. Isolating the plurality of isolated ions comprises: collecting at least a first target ion, but not a second target ion, using the at least one isolation notch for a first period of time; changing at least one property of the at least one isolation notch; and collecting at least the first target ion and the second target ion using the at least one isolation notch for a second period of time.

In some embodiments, a plurality of samples may be labeled with corresponding chemical tags prior to isolating ions from said plurality of samples.

Some embodiments are directed to a mass spectrometer apparatus. The apparatus includes an ion trap for isolating a plurality of isolated ions from a plurality of injected ions; an ion injector for injecting the plurality of injected ions into the ion trap; an isolation waveform generator for creating a dynamic isolation waveform, wherein the isolation waveform generator is coupled to the ion trap such that the dynamic isolation waveform creates at least one isolation notch in the ion trap; and a controller, coupled to the isolation waveform generator, for controlling at least one property of the at least one isolation notch. The controller changes at least one property of the at least one isolation notch. The ion trap collects at least a first target ion, but not a second target ion, before the controller changes the at least one property of the at least one isolation notch. And the ion trap collects at least the first target ion and the second target ion after the controller changes the at least one property of the at least one isolation notch.

In some embodiments, a plurality of samples may be labeled with a corresponding chemical tag prior to isolating ions from said plurality of samples.

Some embodiments are directed to at least one non-transitory computer-readable storage medium comprising computer-executable instructions that, when executed by at least one processor, perform a method of controlling a mass spectrometry device. The method may include: receiving relative abundance information of at least a first target ion and a second target ion in a plurality of precursor ions; computing a dynamic isolation waveform for creating at least one isolation notch for isolating a plurality of isolated ions from a plurality of precursor ions, wherein the relative abundance information, wherein the relative abundance information is used to compute at least one property of the at least one isolation notch to change after a first period of time; instructing the mass spectrometry device to collect at least the first target ion, but not the second target ion, using the at least one isolation notch for the first period of time; and instructing the mass spectrometry device to collect at least the first target ion and the second target ion, using the at least one isolation notch for a second period of time after the first period of time.

In some embodiments, a plurality of samples may be labeled with a corresponding chemical tag prior to isolating ions from said plurality of samples.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an illustration of a dynamic isolation waveform according to some embodiments;

FIG. 2 is an illustration of the effects of a dynamic isolation waveform on the relative abundance of precursor ions;

FIG. 3 is an illustration of MS2 product ion spectra from the isolated precursor ions of FIG. 2;

FIG. 4 is a flowchart of a mass spectrometry process according to some embodiments;

FIG. 5 is a flowchart of a multiplexed mass spectrometry process according to some embodiments;

FIG. 6 is a flowchart of a precursor ion isolation process according to some embodiments;

FIG. 7 is a schematic block diagram of a mass spectrometry device according to some embodiments;

FIG. 8 is a schematic block diagram of a computing environment according to some embodiments; and

FIG. 9 illustrates the amount of time that may be saved by utilizing a dynamic isolation waveforms in a MS2 analysis according to some embodiments.

### DETAILED DESCRIPTION OF INVENTION

The inventors have recognized and appreciated that high throughput may be achieved in mass spectrometry, while retaining accuracy, by selecting multiple m/z ranges (also called “notches”) to co-isolate multiple ions to be used as precursor ions. Selecting multiple notches may increase the number precursor ions.

The inventors have recognized and appreciated that, when isolating a plurality of precursor ions for use in an MS process, it may be desirable for each of the isolated precursor ions to have approximately the same abundance. When using a multi-notch isolation waveform, the relative abundance of the isolated ions selected within each of the notches is determined, at least in part, by the relative abundances of the isolated ions in the plurality of ions from which the isolated ions are isolated. For example, if a first isolated ion is twice as abundant as a second isolated ion in the plurality of ions from which the isolated ions are isolated, then the first isolated ion will be twice as abundant as the second isolated ion after being isolated by the isolation waveform.

The inventors have recognized and appreciated that the relative abundances of precursor ions may be adjusted using a dynamic isolation wave form that changes over time such that a different amount of at least some of the precursor ions are accumulated at different times. For example, the dynamic isolation waveform may change over time to increase the number of notches or change the width of one or more isolation notches.

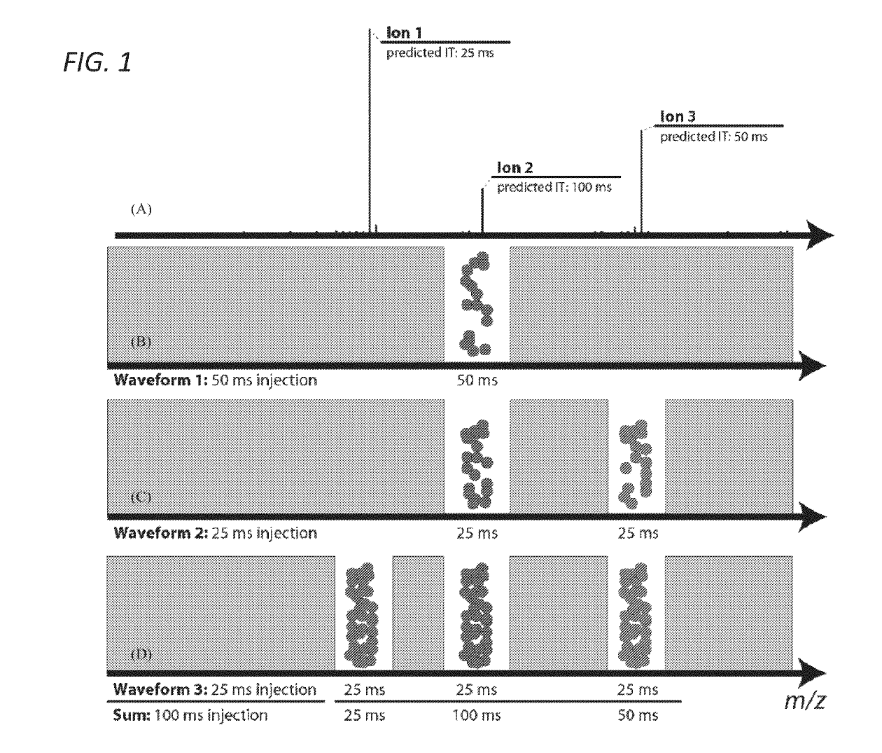

FIG. 1 illustrates an example of a dynamic isolation waveform that may be used to adjust the relative abundance of precursor ions in a mass spectrometry process. In this particular example, the number of notches included in the dynamic isolation waveform changes over time such that the dynamic isolation waveform comprises three static waveforms. It should be understood that the static waveforms comprise a time-varying voltage and are not static to that extent. Rather, the waveforms are static in that the properties of the one or more notches of the waveform are static. The first static waveform (FIG. 1B) includes a single notch, which is maintained for a first period of time, namely 50 ms. After the first period of time, the second static waveform (FIG. 1C), with a second notch in addition to the first notch, is implemented and maintained for a second period of time, namely 25 ms. After the second period of time, the third static waveform (FIG. 1D), with a third notch in addition to the first and second notch, is implemented and maintained for a third period of time, namely 25 ms.

Each of the static waveforms and the amount of time for which each is maintained may be selected based on the m/z spectrum of the ions from which the isolated ions are isolated. For example, FIG. 1A illustrated a spectrum of a plurality of ions from which precursor ions are isolated. The three precursor ions being selected and isolated are Ion 1, Ion 2 and Ion 3. The abundance of each ion in the sample are not equal—there is approximately twice as much Ion 1 in the sample as there is Ion 3 and there is approximately twice as much Ion 3 in the sample as there is Ion 2. A notch for each precursor ion may be determined based on the m/z ratio of each precursor ion and the m/z ratio of any other ions which are not selected as precursor ions from the sample. In the example of FIG. 1, a new notch is added to each subsequent static waveform based on the relative abundances of the precursor ions. Furthermore, the amount of time that each static waveform is used to isolate one or more of the precursor ions may be based on the relative abundances. For example, because Ion 2 is the least abundant of the three precursor ions, the associated notch for isolating Ion 2 is present in each of the static waveforms and, therefore, isolates ions for a longer total period of time than the other two notches. The total amount of time that the notch associated with Ion 2 is used to isolate ions is the sum of the amount of time that each of the static waveforms is used, namely 100 ms (50 ms from the first static waveform, 25 ms from the second static waveform and 25 ms from the third static waveform). Similarly, because Ion 3 is less abundant than Ion 1, the notch associated with Ion 3 is present in both the second and third static waveform. The total amount of time that the notch associated with Ion 3 is used to isolate ions is the sum of the amount of time that each of the static waveforms is used, namely 50 ms (25 ms from the second static waveform and 25 ms from the third static waveform). Because Ion 1 is the most prevalent ion of the three selected precursor ions, its associated notch only appears in the third static waveform and, therefore, only isolates ions for the time that the third static isolation waveform is applied (25 ms). As described, the ratio of the total amount of time for which each notch is applied is the inverse of the ratio of the relative abundances of the three precursor ions. The ratio of relative abundances of the first, second and third ions is 1:¼:½, whereas the ratio of total time that the respective notches are maintained for isolating the first, second and third ions is 1:4:2.

In some embodiments, more than one isolation notch may be added to the isolation waveform at a time. For example, a dynamic isolation waveform may comprises two static isolation waveforms that are applied serially. The first static isolation waveform may only include a first isolation notch, whereas the second static isolation waveform may include the first isolation notch as well as a second and third isolation notch. Similarly, the initial isolation waveform may include any number of notches. Embodiments are not limited to any number of notches or any particular number of notches that may be added at a time. Embodiments are also not limited to a single ion being isolated by each isolation notch. In some embodiments, a single notch of an isolation waveform may isolate a plurality of ions.

Embodiments are not limited to normalizing the relative abundance of precursor ions. In some embodiments, the relative abundance of precursor ions may be adjusted but not normalized. For example, when a first precursor ion is much less abundant than a second precursor ion, the relative abundance of the first precursor ion may be increased in order to raise the signal associated with the product ions of the first precursor ion above the noise level created from the product ions of the second precursor ion.

The relative abundance of the precursor ions used to determine at least one property of the dynamic isolation waveform may be obtained in any suitable way. In some embodiments, a precursor m/z spectrum may be obtained using a survey scan. The survey scan may be performed at a lower resolution than a full MS scan to increase the speed by which the precursor m/z spectrum is obtained. In other embodiments, the relative abundance of the selected precursor ions may be known in advanced and stored on a memory device associated with the MS device. In further embodiments, the relative abundance of selected precursor ions may be calculable from information stored on a memory device associated with the MS device, such as information about the source of the precursor ions. In further embodiments, one or more earlier MS2 analyses may inform relative precursor abundance.

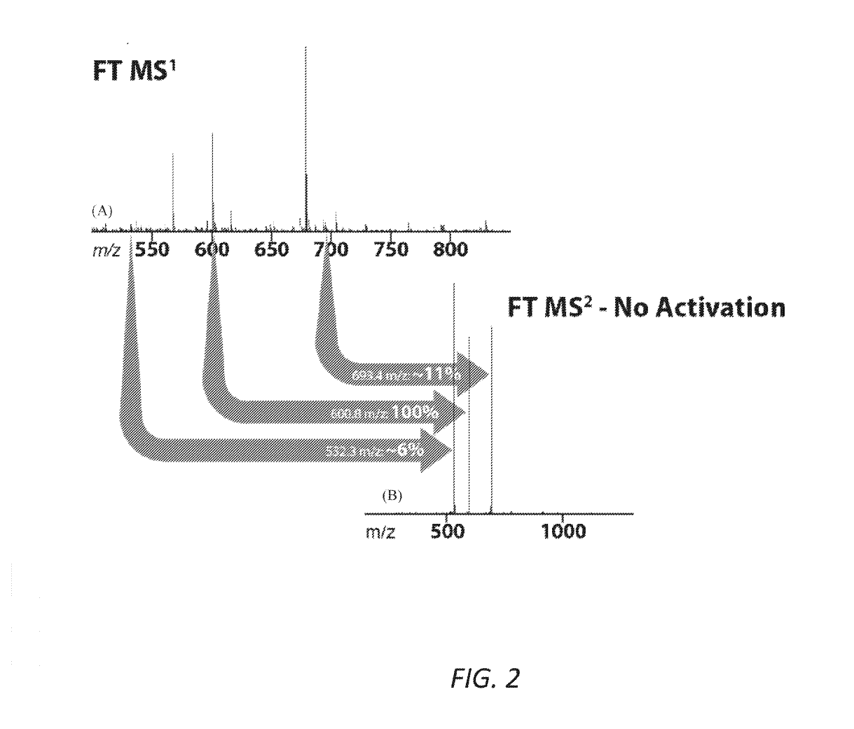

FIG. 2 illustrates an example of the effects of using a dynamic isolation waveform to isolate precursor ions. In this particular example, the spectrum of FIG. 2A is a survey scan spectrum of the plurality of ions generated by the source. There are a plurality of precursor ions, each with varying intensities. Three of the MS 1 ions are selected to be precursors for a subsequent MS stage (MS2). The three precursor ions have a mass-to-charge ratio of 523.3 m/z, 600.8 m/z and 693.4 m/z and have a ratio of relative intensity of 6:100:11. By implementing a dynamic isolation waveform, the relative intensity of the three precursor ions may be adjusted to make the intensities approximately equal. For example, as above, an isolation notch may be created for each precursor ion and the total amount of time that each isolation notch is used to isolate ions is adjusted to compensate for the difference in intensities. FIG. 2B illustrates a resulting MS2 precursor spectrum where the intensity of three precursor ions is approximately equal. Note that there is a high intensity MS1 precursor ion at approximately 675 m/z in the product ion spectrum of FIG. 2A that is no longer present in the isolated precursor spectrum of FIG. 2B because it was not selected as a MS2 precursor ion.

Any suitable ions may be used in the MS techniques of the present application. In the example of FIG. 2, the three precursor ions are peptide ions. However, embodiments are not so limited. For example, some embodiments may use peptides labeled with chemical tags. In other embodiments, molecules other than peptides may be used.

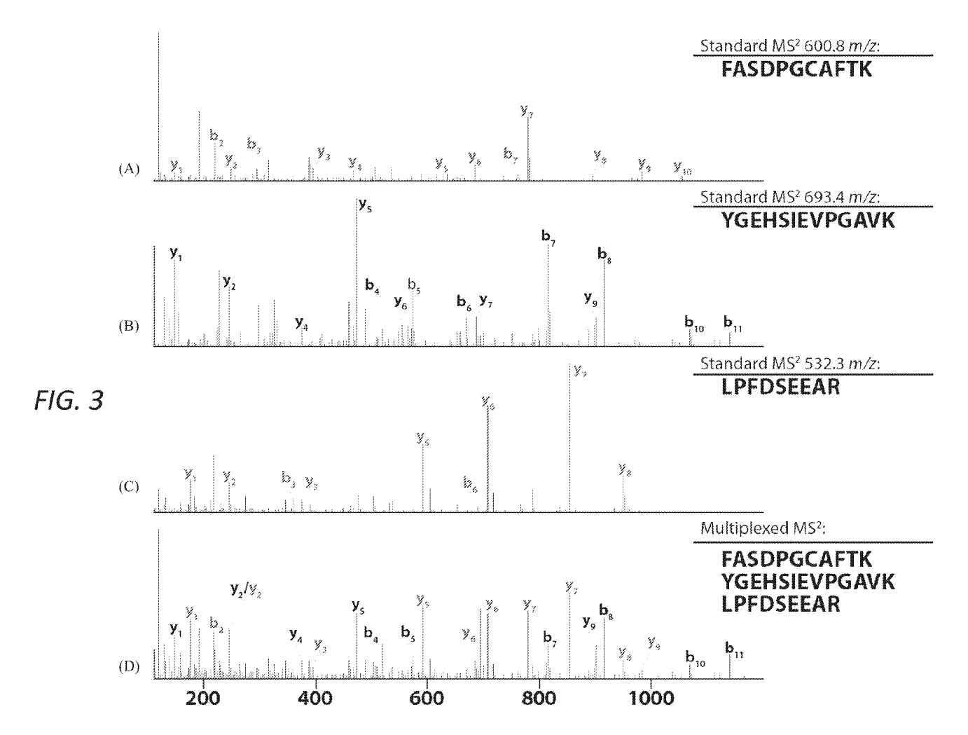

FIG. 3 illustrates the resulting MS2 product ion spectra for the example product ions described in FIG. 2. FIG. 3A-C illustrate the individual MS2 product ion spectra that result from singleplex MS experiments, where each precursor ion is analyzed individually, separate from the other ions. FIG. 3A illustrates the MS2 product ion spectrum for the 600.8 m/z precursor ion (e.g., an ionized FASDPGCAFTK peptide), FIG. 3B illustrates the MS2 product ion spectrum for the 693.4 m/z precursor ion (e.g., an ionized YGEHSIEVPGAVK peptide) and FIG. 3C illustrates the MS2 product ion spectrum for the 523.3 m/z precursor ion (e.g., an ionized LDFDSEEAR peptide). Each of the product ion spectrums shows the resulting peptide fragments after the respective precursor ion is fragmented.

FIG. 3D illustrates the resulting MS2 product ion spectrum from a multiplexed MS2 analysis where all three precursor ions are analyzed simultaneously. The resulting peptide fragments are the same as the peptide fragments of the singleplex MS analyses. However, the amount of time required to perform a multiplexed analysis is significantly shorter than performing three singleplex MS analyses in series. Such a multiplexed MS analysis may not be possible without the normalization of the precursor ions. For example, as illustrated in the precursor ion spectrum of FIG. 2A, prior to normalization, the relative intensities of the precursor ions differ by at least one order of magnitude. If fragmentation was performed on the un-normalized precursor ions and an MS2 analysis was performed, the noise from the precursor ion with the highest abundance (e.g., the unlabeled signals shown in the spectrum of FIG. 3A) would likely make the signal for the lower intensity precursor ions unusable because the signals would be indistinguishable from the noise. Thus, in some embodiments, using a dynamic isolation waveform may make a multiplex MS analysis possible where it was previously not technically feasible.

In some embodiments, the MS analysis may continue to a subsequent MS3 stage where one or more of the MS2 product ions of FIG. 3D are isolated for use as MS3 precursor ions. For example, the MS2 product ions may be labeled with chemical tags, such as isobaric tags. After isolating the selected MS2 product ions for use as MS3 precursor ions, the MS3 precursor ions may be fragmented via any suitable means. In some embodiments, the chemical tags may fragment, resulting in a reporting ions with a different mass for each corresponding chemical tag. Using isobaric chemical tags in this way may allow more efficient quantization of the MS2 product ions as compared to a standard MS2 analysis.

Embodiments are not limited to performing multiplexed MS2 analysis. Any MS scan in which a subsection of the plurality of ionized ions are isolated and further manipulated and analyzed may benefit from the application of dynamic isolation waveforms. In certain embodiments, this may involve multiplexing selected ion monitoring (SIM) analysis where a limited m/z range is analyzed by the MS device. In other embodiments this may entail multiplexing selected reaction monitoring (SRM) or multiple reaction monitoring (MRM) type analyses where only particular MS2 fragment ions are analyzed. Dynamic isolation waveforms may be used with any other suitable mass spectrometry techniques.

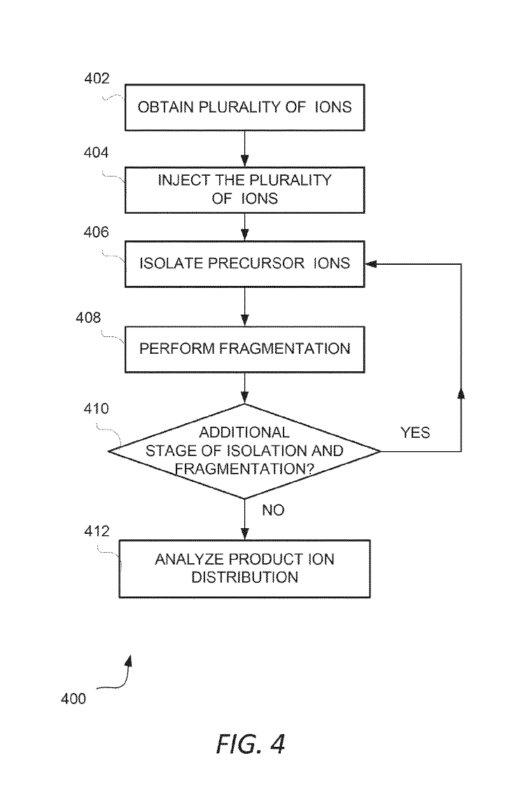

FIG. 4 illustrates a process 400 for performing an MS process in accordance to some embodiments. The process 400 begins at act 402 where a plurality of ions are obtained. The plurality of ions may be obtained in any suitable way. For example one or more samples may be ionized using one out of several ionization techniques, such as electrospray ionization (ESI), matrix-assisted laser desorption/ionization (MALDI), or any other suitable technology. In some embodiments, the samples may be tagged with isobaric chemical tags.

At act 404, the plurality of ions are injected into an ion trap. Injection may be performed in any suitable way. For example, one or more electric and/or magnetic fields may be used to guide the plurality of ions from outside the ion trap into the ion trap. In some embodiments, where ions are created within the ion trap, the injection act may be omitted.

The obtaining act 402 and injecting act 404 may be considered a first stage of MS (MS1). For example, the injected ions, without any additional processing, could be detected and analyzed to determine an associated m/z spectrum. This may be considered an MS1 analysis.

At act 406, precursor ions are isolated from the plurality of ions. Isolation may be performed in any suitable way. Selecting which of the plurality of ions are to be isolated as precursor ions may be done by a user of the MS device or with the assistance of one or more controllers of the MS device. In some embodiments, as described above, the precursor ions are isolated from the plurality of ions using a dynamic isolation wave form. At least one property of the dynamic isolation waveform changes over time. In some embodiments, the property that changes may be the number of isolation notches. In other embodiments, the changing parameter may be the width of one or more isolation notches. Embodiments are not limited to any particular implementation of a dynamic isolation waveform. In some embodiments, the dynamic isolation waveform may include a plurality of static isolation waveforms that are implemented serially, wherein each of the static isolation waveforms are maintained for a respective period of time. In other embodiments, a property of the dynamic isolation waveform may be changed continuously, rather than discretely. For example, a width of one or more notches may be widened or narrowed in a continuous manner rather than switching from a first discrete width to a second discrete width. In another embodiment the amplitude of the isolation waveform may be continuously varied. For example, the time-varying voltage of the isolation waveform is applied to the ion trap at a particular amplitude. This amplitude may change over time. In some embodiments, it may change based on the m/z ratio of the ions selected for isolation. For example, ions with a lower m/z ratio may be more easily ejected from the ion trap. Accordingly, lower amplitude isolation waveforms may be used when isolating ions with low m/z.

By dynamically changing the isolation waveform, the relative abundance of the selected precursor ions may be adjusted. For example, during a first period of time, a first notch may be used that isolates a first precursor ion, but not a second precursor ion. During a second period of time, a second notch may be added to the first notch, or the first notch may be widened, such that the first precursor ion and the second precursor ion are simultaneously isolated. Accordingly, the first precursor ion is given a longer total amount of time to accumulate ions and the relative abundance of the two ions are altered compared to their pre-isolation relative abundances.

At act 408, the precursor ions are fragmented to create a plurality of product ions. Fragmentation may be performed in any suitable way. By way of example and not limitation, the MS2 precursor ions may be fragmented by collision induced dissociation (CID), proton transfer reaction (PTR), infrared multi-photon dissociation (IRMPD), ultraviolet photon dissociation (UVPD), electron transfer dissociation (ETD), electron capture dissociation (ECD), high energy beam type dissociation (HCD), surface induced dissociation (SID), or pulsed-q dissociation (PQD). Embodiments are not limited to any particular process of fragmentation.

At act 410, it is determined whether the present MS process has an additional stage of isolation and fragmentation. For example, if the MS process 400 includes a second isolation act and a second fragmentation act, then the first act of isolation 406 and fragmentation 408 is an MS2 stage and a subsequent stage of isolation and fragmentation is performed as an MS3 stage. Accordingly, if it is determined at act 410 that an additional MS stage is to be performed, the process 400 returns to act 406 for an additional isolation act. In an MS3 embodiment, the MS3 precursor ions may be isolated from the MS2 product ions resulting from the first fragmentation. The isolation and fragmentation may be repeated any suitable number of times until it is determined that no more additional MS stages are to be performed and the process 400 continues to act 412.

At act 412, the final product ion distribution is analyzed. In some embodiments, the m/z/ distribution and relative intensities of the ion signals associated with the different types of tags may be analyzed. The ion signals may be, for example, peptide fragments. In some embodiments, where the molecules injected into the ion trap were tagged with a chemical tag, the ion signals may be reporter ion signals from the chemical tags. Embodiments of the invention are not limited to any particular type of analysis.

Embodiments of process 400 are not limited to the acts illustrated in FIG. 4. For example, there may be additional steps of calculating isolation notch sizes and locations. The calculations may be performed based on the results of a survey scan of the ions present. In some embodiments, the amount of time for which each notch is maintained may also be calculated based on the survey scan.

Moreover, embodiments are not limited to the order of acts shown in FIG. 4. For example, the injection act 404 and the isolation act 406 may occur simultaneously in some embodiments. In some embodiments, when the at least one property of the dynamic isolation waveform is changed, the plurality of ions may be prevented from being injected into the ion trap. This may prevent transient effects to the isolation behavior due to changes in the isolation waveform. For example, when the dynamic isolation waveform is changing from applying a first static waveform to applying a second static waveform, the plurality of ions will not be injected while the switch over occurs. In some embodiments, the plurality of ions may be prevented from being injected by physical blocking the path the plurality of ions traverse to get into the ion trap. In other embodiments, an injector that injects the plurality of ions into the ion trap may be turned off while the switch over occurs.

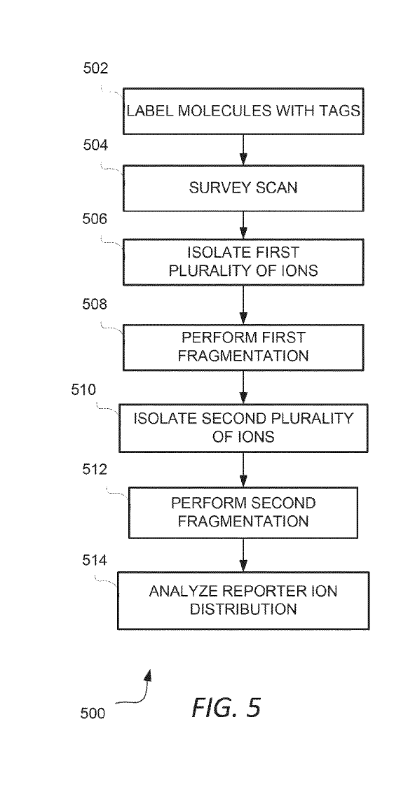

FIG. 5 illustrates an exemplary multiplexed mass spectrometry process 500 according to some embodiments. Using multiplexed MS, multiple samples may be analyzed concurrently, reducing the amount of time needed to analyze the samples. Performing a multiplexed quantitation allows the relative quantities of particular proteins or peptides between samples to be determined. For example, multiplexed quantitation may be used to identify differences between two tissue samples, which may comprise thousands of unique proteins.

In act 502, each sample, comprising a plurality of molecules, is labeled with a respective chemical tag. Any suitable chemical tags may be used. For example, isobaric chemical tags, such as tandem mass tags (TMTs) and isobaric tags for relative and absolute quantitation (iTRAQ) may be used.

At act 504, a survey scan is performed and analyzed to obtain information about the labeled molecules. In some embodiments, a survey scan obtains m/z distribution information and intensity information about the molecules of the plurality of samples. A user of the MS device or a controller of the MS device may analyze the survey scan to determine properties of a dynamic isolation waveform. For example, the location and width of one or more notches may be calculated. Moreover, it is determined how one or more property of the dynamic isolation waveform will change over time. The property being changed may include the number of notches in the isolation waveform and/or the width of one or more notches.

At act 506, a first plurality of ions are isolated using the dynamic isolation waveform. As described above, the isolation act may alter the relative abundances of the first plurality of ions by using a dynamic isolation waveform that isolates various ions of the first plurality of ions for different amounts of time. In some embodiments, the relative abundance of the first plurality of ions may be normalized. However, embodiments of the invention are not so limited. Some embodiments may adjust the relative abundances of the first plurality of ions without normalizing the abundances.

At act 508, a first plurality of ions are fragmented to create MS2 product ions. This may be done in any suitable way. By way of example and not limitation, the MS2 precursor ions may be fragmented by collision induced dissociation (CID), proton transfer reaction (PTR), infrared multi-photon dissociation (IRMPD), ultraviolet photon dissociation (UVPD), electron transfer dissociation (ETD), electron capture dissociation (ECD), high energy beam type dissociation (HCD), surface induced dissociation (SID), or pulsed-q dissociation (PQD). Embodiments are not limited to any particular process of fragmentation.

In some embodiments, the fragmentation of the first plurality of ions results in fragmentation of the tagged molecules without fragmenting the chemical tags themselves. In this way, when the tags are isobaric, the same ions from different samples will have equal masses.

At act 510 a second plurality of ions are isolated from the MS2 product ions resulting from the first fragmentation act 508. The second plurality of ions may be MS3 precursor ions. In some embodiments, a dynamic isolation waveform may be used at this isolation act in a way similar to the above-described technique. However, embodiments are not so limited. In some embodiments, a static isolation waveform may be used.

At act 512, the second plurality of ions are fragmented using any of the aforementioned suitable techniques to create MS3 product ions. In some embodiments, the second fragmentation act 512 results in fragmentation of the chemical tags, generating reporter ions associated with each respective labeled sample.

At act 514, the reporter ion distribution is analyzed to determine the relative abundance of labeled molecules in the plurality of samples. In particular, the distribution and relative intensities of the reporter ion signals associated with the different types of tags may be analyzed. In some embodiments, the other MS3 product ions not associated with the chemical tags may also be analyzed to determine other characteristics of the isolated peptides. Embodiments of the invention are not limited to any particular type of analysis.

In some embodiments, a complementary ion may be analyzed instead of the respective tag's reporter ion. The complementary ion may be a high-mass counterpart to each reporter ion that carries a mass-balancing group of the chemical tag as well as a portion or the entirety of a precursor ion. An analysis of the complementary ions may benefit from a dynamic isolation waveform because a plurality of MS2 product ions may be selected for analysis in an efficient manner. Additional details of the use of high-mass complementary ion analysis in multiplexed MS may be found in U.S. Provisional Application 61/716,806, entitled “Accurate and Interference-Free Multiplexed Quantitative Proteomics Using Mass Spectroscopy” and filed Oct. 22, 2012, which is herein incorporated by reference in its entirety.

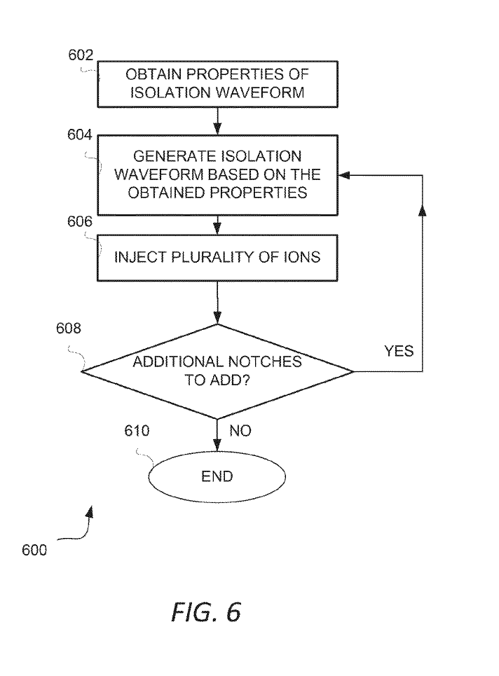

FIG. 6 illustrates a process 600 for isolating precursor ions from a plurality of injected ions using a dynamic isolation waveform according to some embodiments.

At act 602, one or more properties of the dynamic isolation waveform are obtained. This may be done in any suitable way. For example, an analysis of a survey scan may be performed. This survey scan may be used to identify potential ions to be isolated for use as precursor ions in the next stage of the MS procedure. Certain filters may be applied at this stage. For example, only ions with an intensity above a threshold may be considered for use as a precursor ion. Also, a filter based on m/z value may be used. For example, ions with m/z value less than a threshold may not be considered as precursor ions. This threshold may be, by way of example and not limitation, 400 Daltons.

In some embodiments the available product ions for isolation may be determined without performing an analysis of the product ions. For example, if a particular diagnostic test that produces known product ions is being performed, the available product ions may be stored in the analysis software before the analysis begins.

Based on the m/z of the selected precursor ions and the relative intensities of each of the precursor ions, an m/z location and width may be determined for a respective isolation notch of the dynamic isolation waveform. In some embodiments, a series of static isolation waveforms may be determined. Each subsequent static isolation waveform of the series may add one or more isolation notches to the existing isolation notches. In some embodiments, the amount of time each static waveform will be applied to the ion trap may be determined based on the relative abundance of the selected precursor ions.

At act 604, an isolation waveform is generated based on the obtained properties. This may be done in any suitable way. For example, a radio frequency (RF) signal generator may be used to generate the isolation waveforms with the obtained properties. At act 606, a plurality of ions are injected into the ion trap. Act 604 and act 606 may be performed simultaneously for a determined period of time. In some embodiments, where a series of static isolation waveforms is to be applied, a first static isolation waveform is applied to the ion trap for a first period of time while the plurality of ions is injected.

At act 608, it is determined whether there are additional notches to be added to the dynamic isolation waveform. If it is determined that there are additional notches to add, the process 600 returns to act 604 where an isolation waveform with an additional notch is generated and act 606 where the plurality of ions are injected into the ion trap and subjected to the isolation waveform. For example, if a first static isolation waveform is applied during the first iteration through the acts of process 600 and it is determined that there are additional notches to be added, a second static isolation waveform may be implemented during the second iteration through the process of 600. When it is determined that there are no additional notches to add to the dynamic isolation waveform, the process 600 ends at act 610.

In some embodiments, the injection act 606 need not be performed because the ions being isolated may already be in the ion trap. For example, after performing an MS2 fragmentation, the MS2 product ions are already in the trap and MS3 precursor ions may be isolated without injecting additional ions.

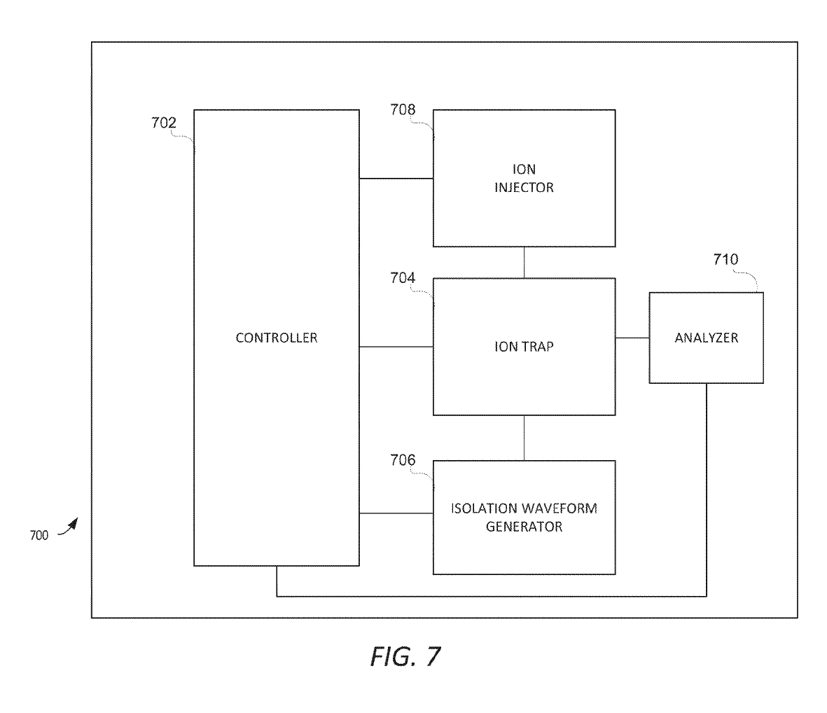

FIG. 7 illustrates a mass spectrometry device 700 according to some embodiments. MS device 700 comprises a controller 702, an ion trap 704, an isolation waveform generator 706, an ion injector 708 and an analyzer 710. MS device 700 is not intended to suggest any limitation as to the scope of use or functionality of the invention. Neither should the MS device 700 be interpreted as having any dependency or requirement relating to any one or combination of components illustrated in the exemplary MS device 700.

MS device 700 comprises at least one controller 702, which may be comprised of hardware, software, or a combination of hardware and software. In some embodiments, controller 702 determines the one or more properties of the dynamic isolation waveform. It may also instruct the ion trap, the isolation waveform generator 706, the ion injector 708 and the analyzer 710 to perform various acts. For example, controller 702 may perform, or instruct other components of MS device 700 to perform, at least some of the acts described in FIG. 4-FIG. 6. In some embodiments, MS device 700 is not limited to a single controller—multiple controllers may be used.

Apparatus 700 comprises an ion trap 704 and an isolation waveform generator 706. Controller 702 may be coupled to the ion trap 704 and/or isolation waveform generator 706 to allow communication. Any suitable form of coupling may be used. For example, the components may be coupled via a system bus. Alternatively, the components of apparatus 700 may be coupled via a communications network, such as an Ethernet network. Embodiments of the invention are not limited to any specific type of coupling.

The ion trap 704 may be any ion trap suitable for use in mass spectrometry. For example, ion trap 704 may be a quadrupole ion trap, a Fourier transform ion cyclotron resonance (FTICR) MS, or an orbitrap MS.

The isolation waveform generator 706 may be any suitable device for generating the isolation waveforms used to isolate ions in the ion trap 704. For example, isolation waveform generator 806 may be a radio frequency (RF) signal generator.

The analyzer 710 may analyze the results obtained from the ion trap. For example, it may determine the m/z spectrum for a given set of ions. In some embodiments, the controller 710 analyzes the results of survey scans performed by the MS device 700. Though the analyzer 710 is shown separate from the controller 702 in FIG. 7, in some embodiments, the analyzer 710 and the controller 702 may be a single physical computing device.

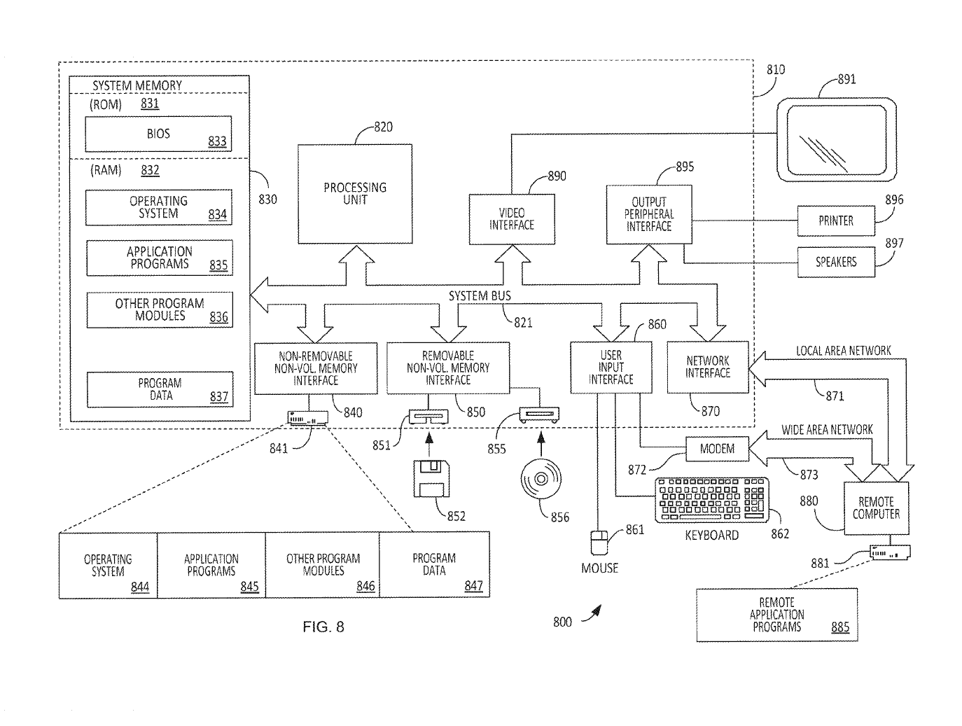

FIG. 8 illustrates an example of a suitable computing system environment 800 on which the invention may be implemented. For example, the controller 702 and/or the analyzer 710 of FIG. 7 may include one or more aspects of the computing system environment 800 of FIG. 8. The computing system environment 800 is only one example of a suitable computing environment and is not intended to suggest any limitation as to the scope of use or functionality of the invention. Neither should the computing environment 800 be interpreted as having any dependency or requirement relating to any one or combination of components illustrated in the exemplary operating environment 800.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 8, an exemplary system for implementing the invention includes a general purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through an non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. A user may enter commands and information into the computer 810 through input devices such as a keyboard 862 and pointing device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through a output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on memory device 881. It will be appreciated that the network connections shown are exemplary and other means of establishing a communications link between the computers may be used.

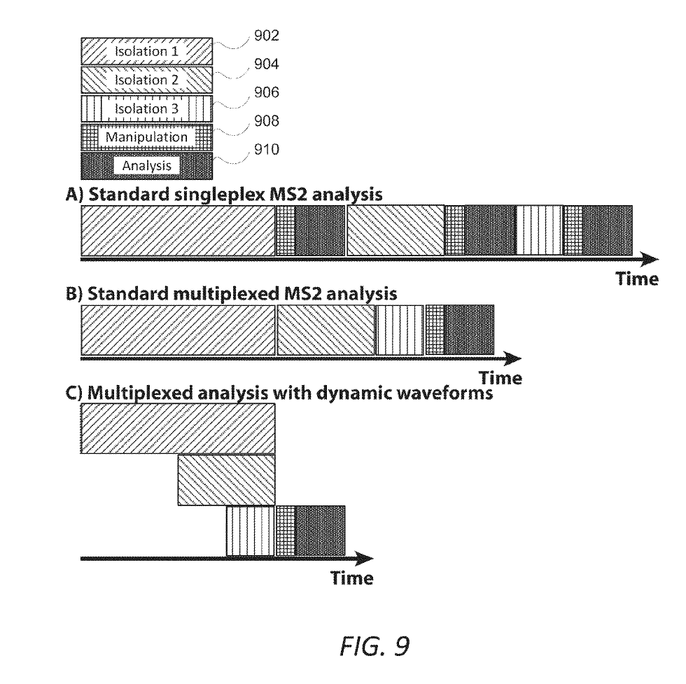

FIG. 9 illustrates the amount of time that may be saved by utilizing dynamic isolation waveforms in an MS2 analysis according to some embodiments by comparing instrument duty cycle of different types of MS2 analysis. Illustrated schematically are three different types of MS2 analysis: a standard singleplex MS2 analysis (FIG. 9A), a standard multiplexed MS2 analysis without dynamic isolation waveforms (FIG. 9B) and a multiplexed MS2 analysis with dynamic isolation waveforms (FIG. 9C). Each of the three types of MS2 analysis include three separate isolation steps 902, 904 and 906 where different precursor ions may be isolated. Each of the three types of MS2 analysis also include manipulation step 908 and an analysis step 910. For the sake of comparison, each isolation step (902, 904 and 906), manipulation step (908) and analysis step (910) take the same amount of time to perform in each of the three types of MS2 analysis. By way of example, the manipulation step 908 may comprise at least a fragmentation step as described above.

FIG. 9A illustrates a standard singleplex MS2 analysis where each precursor ion is analyzed separately after a respective isolation step. For example, a first isolation step 902 is performed where at least a first precursor ion is isolated. The first precursor ion is then manipulated and analyzed prior to the second isolation step 904. A second precursor ion is isolated in the second isolation step 904. Again, the second precursor ion is manipulated 908 and analyzed 910 prior to a third isolation step 906. A third precursor ion is isolated in the third isolation step 906, then manipulated 908 and analyzed 910. This type of singleplex analysis takes the longest amount of time because after each isolation step, a manipulation and analysis step is performed.

FIG. 9B illustrates a standard multiplexed MS2 analysis where the manipulation step 908 and the analysis step 910 are performed together on all precursor ions after all three isolation steps (902, 904 and 906) are performed. The three isolation steps (902, 904 and 906) are performed serially, one after the other. Each isolation step uses a single notch isolation waveform to isolate a respective precursor ion. A dynamic isolation waveform is not used. Accordingly, at any given time, only a single notch is being used to isolate ions. This technique saves time over the standard singleplex MS2 analysis of FIG. 9A because only a single manipulation step 908 and analysis step 910 is performed.

FIG. 9C illustrates a multiplexed analysis using dynamic isolation waveforms according to some embodiments. Initially, during a first isolation step 902, only a first precursor ion is isolated. After a first period of time, the isolation waveform is dynamically changed to isolate a second precursor ion in a second isolation step 904 while still isolating the first precursor ion. After a second period of time, the isolation waveform is again dynamically changes to isolate a third precursor ion in a third isolation step 906 while still isolating the first precursor ion and the second precursor ion. In this way, the amount of time it takes to isolate the same quantity of the three precursor ions is less than the time taken in either FIG. 9A or 9B. Moreover, as in FIG. 9B, a single manipulation step 908 and analysis step 910 is performed, saving additional time with respect to the technique of FIG. 9A.

Accordingly, embodiments of the present application allow for an improvement of instrument duty cycle. Less time is needed to perform similar MS2 analyses and, therefore, more data may be acquired in the same amount of time.

Having thus described several aspects of at least one embodiment of this invention, it is to be appreciated that various alterations, modifications, and improvements will readily occur to those skilled in the art.

For example, while embodiments described above use peptides as the molecules being analyzed by the MS device, any suitable molecules may be analyzed using embodiments of the invention. Furthermore, while only MS2 and MS3 applications were described in detail, any suitable number of MS stages may be used when implementing aspects of the present invention.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of performing mass spectrometry, the method comprising:
isolating a plurality of isolated ions from a plurality of injected ions using a dynamic isolation waveform to create at least one isolation notch, wherein isolating the plurality of isolated ions comprises:
collecting at least a first target ion, but not a second target ion, using the at least one isolation notch for a first period of time;
changing at least one property of the at least one isolation notch; and
collecting at least the first target ion and the second target ion using the at least one isolation notch for a second period of time.

2. The method of claim 1, wherein the plurality of isolated ions are MS2 precursor ions.

3. The method of claim 1, wherein the plurality of isolated ions are MS3 precursor ions.

4. The method of claim 1, wherein the at least one property of the at least one isolation notch is a number of isolation notches created by the dynamic isolation waveform.

5. The method of claim 4, wherein:
the at least one isolation notch comprises a first isolation notch;
changing the at least one property of the at least one isolation notch comprises adding a second isolation notch; and
isolating the plurality of isolated ions further comprises:
injecting ions of the plurality of injected ions into a ion trap device for the first period of time prior to adding the second isolation notch; and
injecting ions of the plurality of injected ions into the ion trap device for a second period of time after adding the second isolation notch.

6. The method of claim 5, wherein:
the first isolation notch isolates at least the first target ion from the plurality of injected ions;
the second isolation notch isolates at least the second target ion from the plurality of injected ions; and
the abundance of the first target ion in the plurality of injected ions is less than the abundance of the second target ion in the plurality of injected ions.

7. The method of claim 6, wherein, at the end of the second period of time, the amount of the first ion that is isolated in the plurality of isolated ions is approximately equal to the amount of the second ion that is isolated in the plurality of isolated ions.

8. The method of claim 5, wherein the first period of time and the second period of time are determined based on a survey scan of the plurality of injected ions.

9. The method of claim 5, wherein adding a second isolation notch comprises adding a plurality of additional isolation notches.

10. The method of claim 9, wherein each of the plurality of additional isolation notches isolates at least one respective target ion from the plurality of injected ions, wherein each of the respective target ions has approximately the same abundance in the plurality of injected ions.

11. The method of claim 5, wherein isolating the plurality of isolated ions further comprises preventing the plurality of injected ions from being injected into the ion trap device while adding the second isolation notch.

12. The method of claim 1, wherein the at least one property of the dynamic isolation waveform is a width of at least one isolation notch created by the dynamic isolation waveform.

13. The method of claim 12, wherein:
changing the at least one property of the at least one isolation notch comprises increasing the width of the at least one isolation notch; and
isolating the plurality of isolated ions further comprises:
injecting ions of the plurality of injected ions into a ion trap device for the first period of time prior to increasing the width of the at least one isolation notch; and
injecting ions of the plurality of injected ions into the ion trap device for a second period of time after increasing the width of the at least one isolation notch.

14. The method of claim 13, wherein:
the at least one isolation notch, prior to increasing the width, isolates at least the first target ion, but not the second target ion, from the plurality of injected ions; and
the at least one isolation notch, after increasing the width, isolates the first target ion and the second target ion from the plurality of injected ions.

15. The method of claim 1, further comprising:
computing one or more properties of the dynamic isolation waveform based on a relative abundance of the first target ion and the second target ion of the plurality of injected ions.

16. The method of claim 1, wherein the at least one property of the at least one isolation notch is an amplitude of the dynamic isolation waveform.

17. The method of claim 1, wherein the plurality of isolated ions are a plurality of precursors ions in a selected ion monitoring analysis.

18. The method of claim 1, wherein the plurality of isolated ions are a plurality of precursors in a multiple reaction monitoring analysis.

19. A mass spectrometer apparatus, comprising:
an ion trap for isolating a plurality of isolated ions from a plurality of injected ions;
an ion injector for injecting the plurality of injected ions into the ion trap;
an isolation waveform generator for creating a dynamic isolation waveform, wherein the isolation waveform generator is coupled to the ion trap such that the dynamic isolation waveform creates at least one isolation notch in the ion trap; and
a controller, coupled to the isolation waveform generator, for controlling at least one property of the at least one isolation notch, wherein the controller changes at least one property of the at least one isolation notch, wherein,
the ion trap collects at least a first target ion, but not a second target ion, before the controller changes the at least one property of the at least one isolation notch; and
the ion trap collects at least the first target ion and the second target ion after the controller changes the at least one property of the at least one isolation notch.

20. The mass spectrometer apparatus of claim 19, wherein the ion trap is selected from the group consisting of a quadrupole ion trap, an orbitrap, and a Penning trap.

21. The mass spectrometer apparatus of claim 19, wherein the at least one property of the at least one isolation notch is a number of isolation notches created by the dynamic isolation waveform.

22. The mass spectrometer apparatus of claim 21, wherein:
the at least one isolation notch comprises a first isolation notch;
the controller adds a second isolation notch after a first period of time by controlling the dynamic isolation waveform created by the isolation waveform generator; and
the ion injector:
injects ions of the plurality of injected ions into a ion trap device for the first period of time prior to adding the second isolation notch; and
injects ions of the plurality of injected ions into the ion trap device for a second period of time after adding the second isolation notch.

23. The mass spectrometer apparatus of claim 22, wherein the controller adds a plurality of additional isolation notches after a first period of time by controlling the dynamic isolation waveform created by the isolation waveform generator.

24. At least one non-transitory computer-readable storage medium comprising computer-executable instructions that, when executed by at least one processor, perform a method of controlling a mass spectrometry device, the method comprising:
receiving relative abundance information of at least a first target ion and a second target ion in a plurality of precursor ions;
computing a dynamic isolation waveform for creating at least one isolation notch for isolating a plurality of isolated ions from a plurality of precursor ions, wherein the relative abundance information, wherein the relative abundance information is used to compute at least one property of the at least one isolation notch to change after a first period of time;
instructing the mass spectrometry device to collect at least the first target ion, but not the second target ion, using the at least one isolation notch for the first period of time; and
instructing the mass spectrometry device to collect at least the first target ion and the second target ion, using the at least one isolation notch for a second period of time after the first period of time.

25. The at least one non-transitory computer-readable storage medium of claim 24, wherein the at least one property of the at least one isolation notch to change is computed such that, the relative abundance of the first target ion and the second target ion collected by the mass spectrometry device will be approximately equal.
